(19) United States
(12) Patent Application Publication
(10) Pub. No.: US 2015/0044572 A1
(43) Pub. Date: Feb. 12, 2015

(54) ELECTRICAL ENERGY STORAGE STRUCTURES

(71) Applicant: BAE SYSTEMS plc, London (GB)

(72) Inventors: Martyn John Hucker, Bristol (GB); Michael Dunleavy, Bristol (GB); Sajad Haq, Bristol (GB); Amy Elizabeth Dyke, Bristol (GB)

(73) Assignee: BAE SYSTEMS plc, London (GB)

(21) Appl. No.: 14/383,416

(22) PCT Filed: Feb. 26, 2013
(86) PCT No.: PCT/GB2013/050471

§ 371 Date: Sep. 5, 2014

(30) Foreign Application Priority Data
Mar. 7, 2012 (GB) 1203997.0

(51) Int. Cl. H01M 2/16; H01M 4/134; H01M 4/24; H01M 4/14

(52) U.S. Cl. CPC H01M 2/1673; H01M 4/14; H01M 4/134; H01M 4/244; H01M 4/248
USPC 429/300; 429/206; 429/246; 429/223; 429/225; 429/231.95; 429/217; 429/219

(57) ABSTRACT

According to the invention there is provided a structural metallic rechargeable battery and a method of producing same. The battery uses one of an acid, alkaline or Li-ion chemistry and the battery has an anode structure, a cathode structure, each of which comprise a conductive foam which contains the active electrochemical reagents, and a structural separator which separates the conductive foams of anode from the cathode respectively. The anode structure and the cathode structure are each formed from a metal sheet or foil.

This invention relates to the formation of load bearing metallic structures or components that also incorporate a means of storing electrical energy. The materials described may described as multi-functional in that the energy storage media is intimately incorporated within the structure and is in itself load bearing and non-parasitic. This approach allows electrical energy to be stored in a highly efficient manner in both gravimetric and volumetric terms especially when compared to conventional batteries, capacitors and supercapacitors.

According to a first aspect of the invention there is provided a structural metallic electrical storage device the device having at least two electrodes, each of the at least two electrodes comprising a metallic element, on a first surface of each of said two elements is a layer of a conductive foam, said foam being in electrical and bonded contact with said element, a structural separator which separates and is bonded to each of the two conductive foams, wherein said foams and structural separator comprise an electrolyte.

According to a further aspect of the invention there is provided a structural metallic battery using one of an alkaline, acid or Li-ion based chemistry, the battery having

an anode structure which comprises a metallic element, comprising on a first surface, a layer of a conductive foam,
a cathode structure which comprises a metallic element, comprising on a first surface, a layer of conductive foam,
a structural separator which is bonded to, and separates the conductive foams of the anode and cathode respectively, wherein said foams contain an electrolyte comprising an electrochemically active material in a binder matrix

Electrochemical cells (both primary and secondary types may be provided, preferably rechargeable batteries. Electrochemical cells covering a wide range of cell chemistries may be embodied, the electrolyte may include a number of known cell chemistries such as, for example: alkaline nickel chemistries (e.g. Ni/Fe, Ni/Cd, Ni/Zn, and Ni/MH), acid based chemistries (e.g. lead-acid) and lithium ion chemistries.

The metallic elements, such as the anode and cathode structures are prevented from coming into direct electrical contact with each other, by means of the structural separator, to prevent an electrical short circuit. The structural separator may be elongate compared to the conductive foams, such that when the device or battery is sealed, the structural separator separates anode and cathode or electrodes. Alternatively additional separators by be used to prevent electrical contact between the anode and cathode layers or electrodes of the storage device.

The battery or device may be sealed by crimping, rolling, folding, welding, or using an adhesive to provide a sealed battery or device.

The binder matrix and further binder matrix may comprise further active reagents to improve the performance of the electrochemical cell, such as for example elastomeric binders, porogens etc. The inclusion of the elastomer binder at less than 50% w/w provides enhanced life-cycling properties, and greater energy storage.

The use of conducting composites as the anode and cathode or electrodes is known, they provide very light and strong structures. However, once they are formed into a shape they cannot be re-worked into further shapes. One advantage of structural metallic batteries and devices is that they may be formed into flat sheets, transported and then shaped via conventional metal processing techniques to a final desired shape, such as, for example car panels may be formed from metal structural batteries.

The metallic elements of the electrodes, anode and cathode, may be independently selected from any metallic material, preferably a highly conductive metal, such as, for example nickel, nickel plated steel, copper. Whilst it may be possible to use carbon as an electrode, it would not be possible to subject the final cell to conventional metal shaping, forming, processing techniques. The anode, cathode elements or electrode may be metal sheets, foil, which then have a metal foam bonded thereto, or the anode or cathode may be formed by deposing at least one layer of a metal on the surface of a conductive foam.

The conductive foams may be independently selected from any metallic material, preferably a highly conductive metal, such as, for example nickel, nickel plated steel, copper. Alternatively the conductive foam is a non-conductive foam with a conductive coating, such as for example a metal coating. In a highly preferred arrangement the conductive foam is a foam formed from a metal, more preferably nickel. The foam must be resistant to the electrochemical chemistries within the cell; otherwise the foam will react and may be consumed during use.

The conductive foam provides a very high surface area current collector, thereby increasing the available charge which may be collected at the anode and cathode or electrodes. If the only contact area was the metallic element i.e. the foil or sheet, then the active surface area would be very low.

The conductive foam is in direct electrical and bonded contact with the metallic elements of the respective anode and cathode structures, this contact may be afforded by any known fixing methods, such as, for example, the use of conductive adhesives, welding, direct fusion or by the deposition of the foam onto the metallic elements.

Metal foils and thin metal sheets may be very flexible unless supported; the combination of the conductive foam, structural separator and metal elements provides a high degree of rigidity to the battery, so as to provide the battery with load bearing properties. The metallic elements and the conductive foams, and additionally the conductive foams and the structural separator are bonded or firmly affixed to provide the structural properties of the structural battery. The bonding reduces the action of shear forces i.e. slip or movement of the respective components when the structural battery is placed under load or stress.

Preferably, the structural separator is formed from a composite material which includes electrically insulating fibres in a further binder matrix, optionally the further binder matrix in the structural separator may be selected from the same materials as the binder matrix, and so may comprise a portion of elastomer binder, preferably fluorinated elastomer binder. The electrically insulating fibres may be glass, polymer, ceramic or textile fibres, and may be selected depending on the desired mechanical or physical properties of the battery. The insulating fibres must also be resistant to the particular chemistry of the cell. Examples of suitable electrically insulating fibres include E-glass fabric, and silicon carbide fibres. Examples of textile fibres include natural fibres such as cotton, and synthetic fibres which are typically polymer fibres such as nylon® and polyester.

In one preferred embodiment, the battery is rechargeable, more preferably a nickel-iron rechargeable battery. The skilled reader will appreciate that in such embodiments, the electrochemically active materials may be nickel hydroxide and iron oxide.

Alternatively the rechargeable battery may be based on lithium ion chemistry.

In a further embodiment the conductive foam and the structural separator may contain a porous additive (i.e. a porogen) which increases access of the electrolyte into said structure. The porous additive may be one or more of a silica, a silica gel or carbon powder.

At least one of the conductive foams may further include an electrically conductive additive such as carbon powder. It will be apparent to the skilled reader that carbon powder can perform a dual role as a porous additive and an electrically conductive additive. At least one of the conductive foams may further include an ion conducting additive such as polyethylene oxide (PEO).

The thickness of the anode structure, cathode structure and/or the structural separator may be conveniently varied in order to provide desired mechanical and electrical properties. These structures may be formed from one or more layers. Variation of the number of layers is one way in which the thickness of these structures may be varied.

The structural separator may additionally include commonly used electrical component separator materials such as microporous polymer films, which may be used in combination with electrically insulating fibres in a binder matrix to aid ion transport.

The electrical storage device may provide a structural electrochemical double layer capacitors (EDLC, commonly referred to as supercapacitors), either alone or in discrete or intimate combinations within the same metallic structure to provide hybrid energy storage. The structural electrochemical double layer capacitor (EDLC) comprises electrodes, without the electrochemically active materials. The structural separator is provided in the same manner as described for the battery application. The addition of an electrolyte results in a functioning EDLC device.

The electrolyte may be an aqueous or gel based electrolyte.

Further, the electrolyte may be a solid polymer electrolyte (SPE). The SPE may include polyvinyl alcohol (PVA), polyethylene oxide (PEO), polyacrylic acid (PAA) or grafted analogues or combinations thereof. Biphasic mixtures of SPE's may be used. Additives may be present in the SPE to modify its electrical, physical or chemical properties.

According to a further aspect of the invention there is provided a panel on a vehicle vessel or craft comprising at least one battery and/or device according to the invention.

A structural metallic energy storage device or battery is one which can be used in place of an existing panel or element, which forms part of a body, such as a replacement panel on a vehicle vessel or craft. A conventional disposable cell, whether in a vehicle or aircraft is exclusively an energy storage device. The batteries and devices as defined herein provide both structural support (in the same fashion as the vehicles original manufactures panel) and provide energy storage.

One advantage of structural metallic energy storage devices is that they may be transported and formed into a final shape, without the electrolyte being present in the cell. The energy storage devices may then be filled, via a filler port, after they have been transformed into a final shape. This allows the devices to be inactive, during any heated processing steps, such as curing any post processing finishing processes, such as painting or lacquering etc. which are often baked to provide the final finish. In addition, finished devices may be transported to their point of use prior to the addition of electrolyte chemicals. This not only reduces their mass for transport (so reducing costs) but increases safety as less active chemicals are present and the devices themselves are electrically inert. In the event of an accident during transport there would be less risk from chemical spills and no possibility of fire due to short circuits. The provision of a filler port allows electrolyte to be filled as required or removed for maintenance, repair or safety reasons to deactivate the battery.

A particular application is seen as providing both structure and power in electrically powered vehicles, vessels or crafts, and where a source of power which does not add significantly to the weight of the system or occupy significant volume will enable the system to remain operational for longer than if conventional batteries were used or provide other performance enhancements such as higher speeds, increased maneuverability or increased payload capacity for example. Batteries used in this way will work well with solar cells, positioned say on the aircraft wings, which can be used to re-charge the cells in flight. Batteries according to the invention may be used for example as wing skins and can be used to provide power for on board electrical systems.

The electrically insulating binder matrix material may include or consist of an open cell foam, a geopolymer or an SPE. In the latter case, the SPE may perform a dual role as both binder and electrolyte.

The rechargeable battery may include a plurality of cells which may be interdigitated, multilayered or spatially distributed within the battery. For example, an aircraft composite wing skin incorporating cells, according to the invention, may have the cells distributed across a large area of wing, either because the cells are connectable to solar cells distributed on the wing skin or because the cells are connectible to distributed power users such as lights, flight control surfaces, valves or sensors for aircraft systems, etc., located in different parts of the wing.

According to a further aspect of the invention there is provided a method of manufacturing a battery defined herein, including the steps of laying up, either side of a structural separator,

an anode structure which comprises a metallic element, comprising on a first surface, a layer of a conductive foam,
a cathode structure which comprises a metallic element, comprising on a first surface, a layer of conductive foam,
causing bonding of said separator structure to the anode and cathode foams

There is further provided a method of manufacturing a structural metallic electrical energy storage device the device including an anode structure which comprises a metallic element, comprising on a first surface, a layer of a conductive foam, and a cathode structure which comprises a metallic element, comprising on a first surface, a layer of a conductive foam, the structural separator separating the anode from the cathode and being adapted to contain an electrolyte; the method including the steps of laying up, either side of the structural separator, the anode structure and the cathode structure, wherein the conductive foams are both in direct contact with the structural separator.

An energy storage device according to the invention may conveniently be made by any known manufacturing processes compatible with the cell chemistry concerned. One advantage of using these commonly used techniques is that devices of the invention may be employed to replace already existing parts made by the same techniques but not having the advantage of an energy storage device formed integral therewith.

Devices according to the invention may be used in new designs or to replace worn, damaged or outdated parts of any items which can be manufactured of a metallic material. For example, vehicles, whether land, air, space or water born, may have parts manufactured with integral cells, according to the invention. Examples of such use may include wing skins on aircraft, and in particular unmanned air vehicles, where devices according to the invention may be used to power structural monitoring equipment, control surfaces, cameras, lights etc. Where the devices may be exposed to sunlight or be otherwise connectible to photovoltaic equipment, the cell or cells may be charged using such equipment. Owing to the ability of cells in batteries being able to be positioned anywhere; where the battery is a wing skin, the photovoltaic cells may be positioned adjacent the cells of the invention to avoid unnecessary wiring. Conveniently, where the device is used to replace a panel on an existing body, vehicle, vessel or craft, the device may preferably be engineered to the same dimensions as the original panel.

Further potential uses on vehicles may include body panels on hybrid or electric drive vehicles where the devices of the invention can be used to save weight and bulk, compared to conventional devices. Such devices may also find use on free flooding hydrodynamic hulls of, say, submersible remotely operated vehicles. The devices would be especially useful on any vehicle where weight or bulk was at a premium like an aircraft or a satellite. On a satellite the saving in space and bulk of devices according to the invention which could be used to power various systems would potentially be of great benefit and would likely increase the payload capability of the satellite substantially.

A further advantage of using cells incorporated into such batteries is that the mass of the devices, where desired, may be distributed integrally throughout the host structure. This can be very beneficial, for example, when sudden shocks occur. Such shocks might occur, for example, for vehicles involved in collisions. Under such conditions the integral nature of the devices will prevent their tending to act as uncontained missiles. Conventional batteries, when used in military tanks or armoured carriers for example, will be liable to act as uncontained missiles during an explosion or under projectile impact. However, integrated devices according to the invention will not form separate detached objects and will avoid this problem.

An example of a battery according to the invention in which rechargeable batteries are evenly distributed is internal panelling for a vehicle which may be in the form of a spall liner, as used in military vehicles. These vehicles are often used for reconnaissance patrols during which they spend a considerable time with their engines switched off on ‘silent watch’. In these circumstances the batteries may be used to provide power for sensors, communications, life support, air conditioning, etc. and there must be enough residual battery power to restart the vehicle engine. The spall liners will form part of the vehicle armour but will also provide additional power without taking up any further limited internal space and will not add further weight or bulk to the vehicle. The extra weight of additional conventional batteries would normally reduce maneuverability and speed of the vehicle. Batteries according to the invention may also comprise external vehicle armour. The distributed nature of the batteries has the advantage of easing the design of an aircraft for the correct weight distribution. There is no parasitic mass which has to be positioned wherever space is available on the aircraft and which forms a concentrated mass which must be balanced in order to trim the aircraft and which must be wired to equipment to be powered and also to a power source. The mass of supports and packaging for the batteries may also be avoided as the structural batteries will be integral with the aircraft itself. The batteries may be positioned closer to equipment to be powered as they form part of the aircraft structure and do not need separate accommodation. Thus, for example cabin interior lights may use a battery supply from cells comprising cabin panelling in which the lighting is mounted and wing lights or systems equipment may be supplied by power from batteries according to the invention comprising part of the wing structure. Instruments in the cockpit may be powered by batteries, according to the invention, comprising the instrument panel itself.

Of potential great importance would be the use of batteries according to the invention in electrical or electronic equipment, in particular portable equipment such as computers, personal digital assistants (PDAs), cameras and telephones. Here mountings for such equipment such as circuit boards, casings and the like could be made according to the invention which would, again, assist in cutting down the weight and bulk of such items enabling them to be lighter, smaller and possibly cheaper, owing to the reduced part count. In addition, the perennial problem of heat dissipation in portable equipment powered by batteries could be alleviated by incorporating the cells in, for example, the casing of a portable computer where they could dissipate heat much more easily with the possible avoidance of the need for cooling fans.

For energy capture applications, wind turbine casings and solar array support structures could be fabricated from batteries made according to the invention to cut down on weight and bulk.

Whilst the invention has been described above, it extends to any inventive combination of the features set out above, or in the following description, drawings or claims.

Exemplary embodiments of the battery in accordance with the invention will now be described with reference to the accompanying drawings in which:

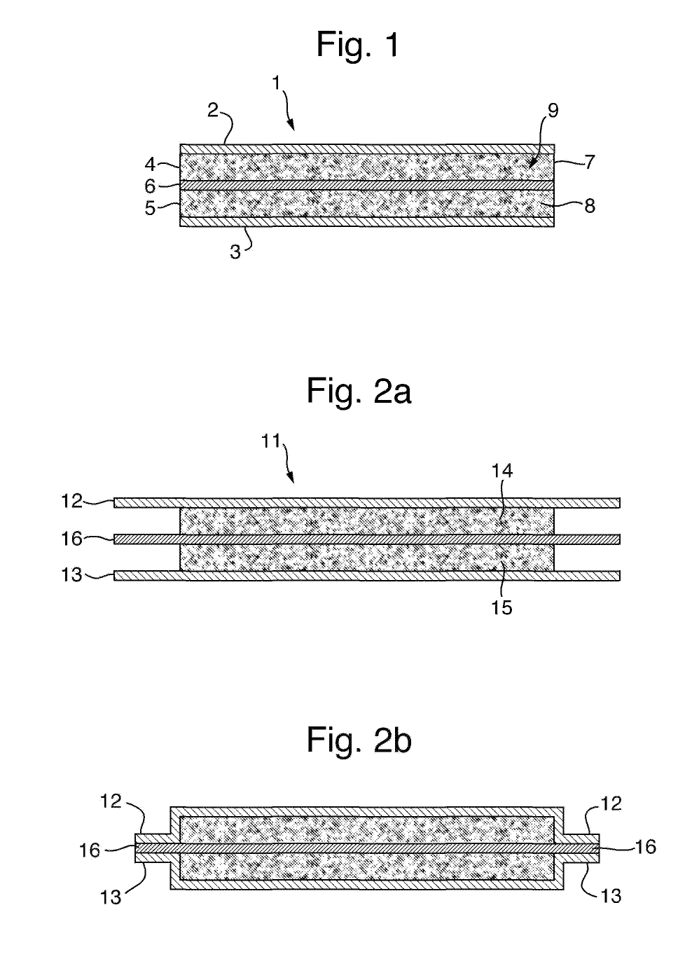

FIG. 1 shows a cross sectional side view of a rechargeable electrochemical cell,

FIGS. 2a and 2b show a cross sectional side view of a rechargeable electrochemical cell with elongate anode, cathode and separator

The invention provides rechargeable batteries using one of an acid, alkaline or Li-ion chemistry and formed at least in part from metallic anode and cathodes with conductive foamed electrolyte filed cores, thereby imparting desired structural properties. FIG. 1 shows an example of a rechargeable battery 1 of the invention, comprising an anode structure 2 which is spaced apart from a cathode structure 3 by a structural separator 6. The anode and cathode structures 2, 3 may be connected to suitable electrode contacts (not shown) to permit charging and discharging of the cell in the usual manner,

The anode 2 has a conductive foam 4, on a first surface, and the cathode 3 has a conductive foam 5 on a first surface and the foams 4 and 5 are separated by the structural separator 6. The structural separator 16 may be formed from composite material comprising suitable fibres in a binder matrix.

A representative example of an alkaline battery in the form of a nickel-zinc battery will now be described, The anode structure 2 is metal sheet formed from steel comprising a nickel coating The electrolyte 7 in the anode may comprise porous carbon powder and nickel hydroxide (Ni(OH)₂) powder, all of which is mixed in a binder.

The cathode structure 3 is a metal sheet formed from steel comprising a nickel coating. The electrolyte 8 in the cathode conductive foam may also contain porous carbon powder and zinc oxide (ZnO) powder, all of which is mixed thoroughly in a binder prior to use. Typically, the number of moles of zinc oxide used is approximately half that of the nickel hydroxide, in view of the stoichiometry of the electrochemical reaction. The electrochemistry of the nickel zinc battery will be well known to the skilled reader, and therefore further details are not provided herein. The active additives in the anode and cathode structures (the nickel hydroxide, zinc oxide and carbon powder) are typically present as fine powders having particle sizes in the range 1 to 10 μm.

The structural separator 6 is formed from a plain weave E-glass fabric embedded in the binder matrix. Other electrically insulating fibres such as silicon carbide which provide suitable structural reinforcement might be used instead. Other separators such as microporous polymer films may be used either alone or in combination with the glass fabric. The structural separator 6 contains an aqueous electrolyte consisting of 40% by weight potassium hydroxide in deionised water. Zinc oxide is dissolved in this solution until saturation or near saturation is achieved.

The electrolyte is stored within the pores of the conductive foams 4 and 5. A porous additive, such as a silica or a silica gel, may be used to provide a more open cell structure or a microporous polymer film may be employed. Vents may be provided to control the release of gases during overcharge conditions and fill/drain ports may be fitted to permit the introduction and removal of the aqueous electrolyte for maintenance or storage.

The battery of the invention can be manufactured in different ways. For example, it is possible to fully manufacture each of the anode and cathode structures and the structural separator separately and subsequently bond these completed structures together. Alternatively, each structure may be produced separately.

Turning to FIGS. 2a and 2b, the anode 12, cathode 13 and structural separator s are elongate with respect to the conductive foams 14, 15. The cell 11 is sealed to envelope the foams, and prevent leakage of the electrolyte from within the foam by crimping, folding, welding or using an adhesive to secure the anode and cathode, so as to prevent an electrical short, as shown in FIG. 2b.

There are numerous variations on the embodiment shown in FIG. 1. Other alkaline batteries such as nickel-iron, nickel-cadmium, nickel metal hydride (NiMH) and silver-zinc might be produced in accordance with the invention. Alternatively, a lead acid battery could be used with lead oxide being used as the active material in the cathode and lead in the anode with sulphuric acid acting as the electrolyte.

Table 1, below, shows alternative chemistries for the positive active material, the negative active material and the electrolyte.

TABLE 1

| | +ve active | −ve active | |
|---|---|---|---|
| Cell type | material | material | Electrolyte |
| Nickel- | Nickel hydroxide | Zinc oxide | 40% KOH solution |
| zinc | | | (aqueous) |
| Nickel- | Nickel hydroxide | Iron oxide | 40% KOH solution |
| iron | | | (aqueous) |
| Lead-acid | Lead oxide | Lead | 4.2M Sulphuric acid |
| | | | (aqueous) |

Features and techniques which are known in the art of alkaline rechargeable batteries may be used in conjunction with the present invention. For example, nickel-zinc battery technology developed by PowerGenix Corp, of San Diego, Calif. 92131-1109, USA may be incorporated into the present invention.

Other electrolyte systems may be used. For example, a porous structural separator may be produced by using a geopolymer or an open cell foam. A gel electrolyte may be produced by adding gelling agents to an aqueous electrolyte solution. In an alternative approach, a solid polymer electrolyte (SPE) or a SPE blend may be used in the structural separator, for example to act as a binder and an electrolyte.

The anode, cathode and structural separator s are not necessarily planar. Non-planar configurations may be employed, for example, to provide a curved or even a generally tubular battery structure, or to provide batteries which can be shaped to any currently existing shaped panel. The structures of the invention are well suited for such configurations. The battery may comprise a number of electrodes and secondary electrochemical cells, each cell comprising anode, cathode and a structural separator.

1. A structural metallic battery using one of an alkaline, acid or Li-ion based chemistry, the battery comprising:
an anode structure which comprises a metallic element, comprising on a first surface, a layer of a conductive foam;
a cathode structure which comprises a metallic element, comprising on a first surface, a layer of conductive foam; and
a structural separator which is bonded to, and separates the conductive foams of the anode and cathode respectively, wherein said foams contain an electrolyte comprising an electrochemically active material in a binder matrix.

2. A battery according to claim 1, wherein the structural separator is formed from a composite material, which includes electrically insulating fibres in a further binder matrix.

3. A battery according to claim 1, wherein the conductive foam comprises a metal foam.

4. A battery according to claim 1, wherein the battery comprises a filler port such that electrolyte is removable from the battery.

5. A battery according to claim 1, wherein the separator is elongate.

6. A battery according to claim 1, wherein the battery is rechargeable.

7. A battery according to claim 1, wherein the battery comprises an aqueous liquid or gel electrolyte.

8. A battery according to claim 1, comprising a nickel-zinc, nickel-iron, nickel-cadmium, nickel metal hydride, lead acid or silver-zinc, or Li-ion electrochemically active materials.

9. A battery according to claim 1, wherein one or more of the anode structure, the cathode structure and the structural separator comprises a porous additive which increases access of the electrolyte into said structure.

10. A battery according to claim 1, wherein the binder matrix or a further binder matrix comprises an epoxy resin.

11. A panel on a vehicle vessel or craft comprising at least one battery and or one structural metallic electrical storage device according to claim 1.

12. A method of manufacturing a structural metallic battery that uses one of an alkaline, acid or Li-ion based chemistry, the method comprising:
laying up, either side of a structural separator:
an anode structure which comprises a metallic element having on a first surface, a layer of a conductive foam; and
a cathode structure which comprises a metallic element, having on a first surface, a layer of conductive foam; and
causing bonding of said structural separator to the anode and cathode foams, such that said structural separator separates the conductive foams of the anode and cathode respectively, and wherein said foams contain an electrolyte comprising an electrochemically active material in a binder matrix.

13. A structural metallic electrical storage device, the device having:
at least two electrodes, each of the at least two electrodes comprising a metallic element, wherein on a first surface of each of said two elements is a layer of a conductive foam, said foam being in electrical and bonded contact with said element; and
a structural separator which separates and is bonded to each of the two conductive foams, wherein said foams and structural separator comprise an electrolyte.

14. A device according to claim 13, wherein the structural separator is formed from a composite material, which includes electrically insulating fibres in a further binder matrix.

15. A device according to claim 13, wherein the conductive foam comprises a metal foam.

16. A device according to claim 13, wherein the device comprises a filler port such that electrolyte is removable from the battery.

17. A device according to claim 13, comprising a nickel-zinc, nickel-iron, nickel-cadmium, nickel metal hydride, lead acid or silver-zinc, or Li-ion electrochemically active materials.

18. A device according to claim 13, wherein one or more of the electrodes and the structural separator comprises a porous additive which increases access of the electrolyte into said structure.

19. A device according to claim 13, wherein the conductive foam comprises a non-conductive foam core having a conducive coating thereon.

20. A battery according to claim 1, wherein the conductive foam comprises a non-conductive foam core having a conducive coating thereon.
